(19) United States
(12) Patent Application Publication
(10) Pub. No.: US 2018/0082653 A1
(43) Pub. Date: Mar. 22, 2018

(54) DISPLAY PANEL DRIVING CIRCUIT, DISPLAY PANEL DRIVING METHOD, AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Jianming WANG, Beijing (CN); Zhihua SUN, Beijing (CN); Guohuo SU, Beijing (CN); Xu ZHANG, Beijing (CN); Zhihao ZHANG, Beijing (CN)

(21) Appl. No.: 15/526,275

(22) PCT Filed: Oct. 31, 2016
(86) PCT No.: PCT/CN2016/103962

§ 371 Date: May 11, 2017

(30) Foreign Application Priority Data
Jan. 8, 2016 (CN) 201610010354.3

(51) Int. Cl. G09G 3/36

(52) U.S. Cl. CPC G09G 3/3688; G09G 3/3677; G09G 2330/06; G09G 2370/08; G09G 3/3648

(57) ABSTRACT

The present disclosure provides a display panel driving circuit, including: a master source driving circuit, a slave source driving circuit, and a gate electrode driving circuit. The master source driving circuit is configured to convert an input control signal from an external display control board to a first data-driving control signal and a first gate-driving control signal, and convert a first data signal from the external display control board to a second data signal. The slave source driving circuit is coupled to the master source driving circuit and data lines of a display panel, and is configured to receive the first data-driving control signal and the second data signal. The gate electrode driving circuit is coupled to the master source driving circuit and gate lines of the display panel, and is configured to receive a first gate-driving control signal.

### CROSS-REFERENCE TO RELATED APPLICATION

This application claims priority of Chinese Patent Application No. 201610010354.3, filed on Jan. 8, 2016, the contents of which is incorporated by reference in the entirety.

### TECHNICAL FIELD

The present disclosure generally relates to display panel driving technology, more particularly, to a display panel driving circuit, a display panel driving method, and a display device.

### BACKGROUND

With the continuous development of liquid crystal display (LCD) technology, liquid crystal panels have many advantages due to their low cost, and broad range development. In large-scale display devices containing a large sized display panel, the signal transmission lines are relatively long, thus the display devices may be easily affected by electromagnetic interference.

### SUMMARY

One aspect of the present disclosure provides a display panel driving circuit, including: a master source driving circuit, a slave source driving circuit, and a gate electrode driving circuit. The master source driving circuit is configured to convert an input control signal from an external display control board to a first data-driving control signal and a first gate-driving control signal, and convert a first data signal from the external display control board to a second data signal. The slave source driving circuit is coupled to the master source driving circuit and data lines of a display panel, and is configured to receive the first data-driving control signal and the second data signal. The gate electrode driving circuit is coupled to the master source driving circuit and gate lines of the display panel, and is configured to receive a first gate-driving control signal.

Optionally, a frequency of the first data-driving control signal and a frequency of the first gate-driving control signal are both higher than a frequency of the input control signal, and a frequency of the second data signal is higher than a frequency of the first data signal.

Optionally, the master source driving circuit comprises a master source driving unit and a first conversion unit; the master source driving unit is configured to receive the input control signal and convert the input control signal to a second data-driving control signal and a second gate-driving control signal; and the first conversion unit is configured to convert the second data-driving control signal to the first data-driving control signal, convert the second gate-driving control signal to the first gate-driving control signal, and convert the first data signal to the second data signal.

Optionally, a type of the input control signal, a type of the second data-driving control signal, a type of the second gate-driving control signal, and a type of the first data signal are the same.

Optionally, the master source driving unit is configured to receive the first data signal from the external display control board, and transmit the first data signal to the first conversion unit.

Optionally, the first conversion unit is configured to receive the first data signal from the master source driving unit.

Optionally, the slave source driving circuit includes a second conversion unit and a slave source driving unit. The second conversion unit is configured to receive the first data-driving control signal and the second data signal, convert the first data-driving control signal to the second data-driving control signal, and convert the second data signal to the first data signal; and the slave source driving unit is configured to provide data signals to the data lines of the display panel based on the second data-driving control signal and the first data signal.

Optionally, the gate electrode driving circuit includes a third conversion unit and a gate electrode driving unit. The third conversion unit is configured to receive the first gate-driving control signal, and convert the first gate-driving signal to the second gate-driving control signal; and the gate electrode driving unit is configured to drive the gate lines on the display panel based on the second gate-driving control signal.

Optionally, the display panel driving circuit includes one or more slave source driving circuits, or one or more gate electrode driving circuits.

Optionally, the input control signal and the first data signal are TTL signals or CMOS signals, and the first data-driving control signal, the first gate-driving control signal, and the second data signal are HSTL signals or SSTL signals.

Optionally, the input control signal and the first data signal are LVDS signals, and the first data-driving control signal, the first gate-driving control signal, and the second data signal are Mini-LVDS signals.

Optionally, the first conversion unit includes: a first input terminal; a first output terminal; a first conversion transistor, wherein a gate electrode of the first conversion transistor is coupled to the first input terminal, a source electrode of the first conversion transistor is configured to receive a first voltage, and a drain electrode of the first conversion transistor is coupled to the first output terminal; and a second conversion transistor. A gate electrode of the second conversion transistor is coupled to the first input terminal, a drain electrode of the second conversion transistor is connected to the first output terminal, and a source electrode of the second conversion transistor is configured to receive a second voltage, and the first conversion transistor is a p-type transistor and the second conversion transistor is an n-type transistor.

Optionally, the second conversion unit includes: a second input terminal; a second output terminal; and a first operational amplifier. An inverting input terminal of the first operational amplifier is coupled to the second input terminal, a forward input terminal of the first operational amplifier is configured to receive a first supply voltage via a first resistor and receive a second supply voltage via a second resistor, and an output terminal of the first operational amplifier is coupled to the second output terminal.

Optionally, the third conversion unit includes: a third input terminal; a third output terminal; and a second operational amplifier. An inverting input terminal of the second operational amplifier is coupled to the third input terminal, a forward input terminal is configured to receive the first supply voltage via a third resistor and receive the second supply voltage via a fourth resistor, and an output terminal of the second operational amplifier is coupled to the third output terminal.

Another aspect of the present disclosure provides a driving method for a display panel, applied to the disclosed display panel driving circuit, including: converting the input control signal, by the master source driving circuit, from the external display control board to the first data-driving control signal and the first gate-driving control signal, and converting, by the master source driving circuit, the first data signal from the external display panel to the second data signal; receiving, by the slave source driving circuit, the first data-driving control signal and the second data signal; and receiving, by the gate electrode driving circuit, the first gate-driving control signal.

Optionally, the frequency of the first data-driving control signal is higher than the frequency of the input control signal, the frequency of the first gate-driving control signal is higher than the frequency of the input control signal, and the frequency of the second data signal is higher than the frequency of the first data signal.

Optionally, the driving method further including: converting, by the master source driving circuit, the input control signal from the external display control board to the first data-driving control signal and the first gate-driving control signal, and converting, by the master source driving circuit, the first data signal from the external display control board to the second data signal; receiving, by the master source driving unit, the input control signal and converting the input control signal to the second data-driving control signal and the second gate-driving control signal; and converting the second data-driving control signal to the first data-driving control signal, converting the second gate-driving control signal to the first gate-driving control signal, and converting the first data signal to the second data signal, by the first conversion unit.

Optionally, the driving method further includes: receiving the first data signal from the external display control board and transmitting the first data signal to the first conversion unit by the master source driving unit; and receiving the first data signal from the master source driving unit by the first conversion unit. The type of the input control signal, the type of the second data-driving control signal, the type of the second gate-driving control signal, and the type of the first data signal are the same.

Optionally, receiving the first data-driving control signal and the second data signal by the slave source driving circuit includes: receiving, by the second conversion unit, the first data-driving control signal and the second data signal; converting, by the second conversion unit, the first data-driving control signal to the second data-driving control signal, and converting, by the second conversion unit, the second data signal to the first data signal; and providing, by the slave source driving unit, data signals to the data lines of the display panel based on the second data-driving control signal and the first data signal.

Optionally, receiving the first gate-driving control signal by the gate electrode driving circuit includes: receiving the first gate-driving control signal by the third conversion unit; converting, by the third conversion unit, the first gate-driving control signal to the second gate-driving control signal; and driving, by the gate electrode driving unit, the gate lines in the display panel based on the second gate-driving control signal.

Another aspect of the present disclosure provides a display device, including a display panel and a disclosed display panel driving circuit for driving the display panel.

### BRIEF DESCRIPTION OF THE FIGURES

The following drawings are merely examples for illustrative purposes according to various disclosed embodiments and are not intended to limit the scope of the present invention.

FIG. 1 is a diagram illustrating an exemplary display panel driving circuit according to disclosed embodiments;

FIG. 2 is a diagram illustrating an exemplary master source driving circuit included in a display panel driving circuit according to disclosed embodiments;

FIG. 3 is a diagram illustrating an exemplary slave source driving circuit included in a display panel driving circuit according to disclosed embodiments;

FIG. 4 is a diagram illustrating an exemplary gate electrode driving circuit included in a display panel driving circuit according to disclosed embodiments;

FIG. 5A is a circuit diagram illustrating a first conversion unit included in a master source driving circuit of an exemplary display panel driving circuit according to disclosed embodiments;

FIG. 5B is another circuit diagram illustrating a first conversion unit included in a master source driving circuit of an exemplary display panel driving circuit according to disclosed embodiments;

FIG. 6A is a circuit diagram illustrating a second conversion unit included in a slave source driving circuit of an exemplary display panel driving circuit according to disclosed embodiments;

FIG. 6B is a circuit diagram illustrating a third conversion unit included in a gate electrode driving circuit of an exemplary display panel driving circuit according to disclosed embodiments; and

FIG. 7 is a diagram illustrating an exemplary display device according to disclosed embodiments.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

Often, the source driving circuit included in a display device is connected to or coupled to a display control board directly through a flexible printed circuit (FPC) board. Such a driving circuit may be unable to realize the adjustable speed control of data-driving control signal and gate-driving control signal, and fail to increase the signal frequency, namely, speed, during the data transmission process. This may result in a slow speed of signal transmission, a high power consumption, as well as considerable impact from electromagnetic interference. In the present disclosure, the term “connected to” and the term “coupled to” may be interchangeable. Being coupled to an object may include but may not be limited to being electrically coupled to the object.

The present disclosure provides a display panel driving circuit, a display panel driving method, and a display device. The disclosed display panel driving circuit, display panel driving method and display device may not only realize the adjustable speed control of data-driving control signals and gate-driving control signals, but may also solve problems of slow-speed, high power consumption, and display panels being susceptible to electromagnetic interference in existing driver circuit signal transmission. Further, a driving method of master-slave source driving circuits in the embodiments of the present disclosure can be used in many display panel driving circuits, thus providing a different display panel driving circuit design.

In some embodiments, the display panel driving circuit may include a master source driving circuit, a slave source driving circuit, and a gate electrode driving circuit. The master source driving circuit may convert an input control signal from an external display control board into a first data-driving control signal and a first gate-driving control signal, and convert a first data signal from the external display control board to a second data signal. The slave source driving circuit may be connected to the master source driving circuit and to data lines of a display panel, and be configured to receive the first data-driving control signal and the second data signal. The gate electrode driving circuit may be connected to the master source driving circuit and to gate lines of the display panel, and be configured to receive a first gate-driving control signal. The frequency of the first data-driving control signal may be higher than a frequency of an input control signal. The frequency of the first gate-driving control signal may be higher than the frequency of the input control signal. The frequency of the second data signal may be higher than a frequency of the first data signal.

In operation, a display panel driving circuit may include one or more slave source driving circuits. A plurality of slave source driving circuits may be arranged sequentially on top of a display panel from left to right, and may drive data in multi-column data lines longitudinally arranged on the disclosed display panel. A display panel driving circuit may include one or more gate electrode driving circuits. A plurality of gate electrode driving circuits may be arranged sequentially on two sides of the display panel from top to bottom, and may drive gate electrodes in a multi-row gate lines horizontally arranged on the disclosed display panel.

The voltages and speeds of the first data-driving control signal, the second data signal, and the first gate-driving control signal may be adjusted to realize low power consumption, low electromagnetic interference, and high-speed signal transmission.

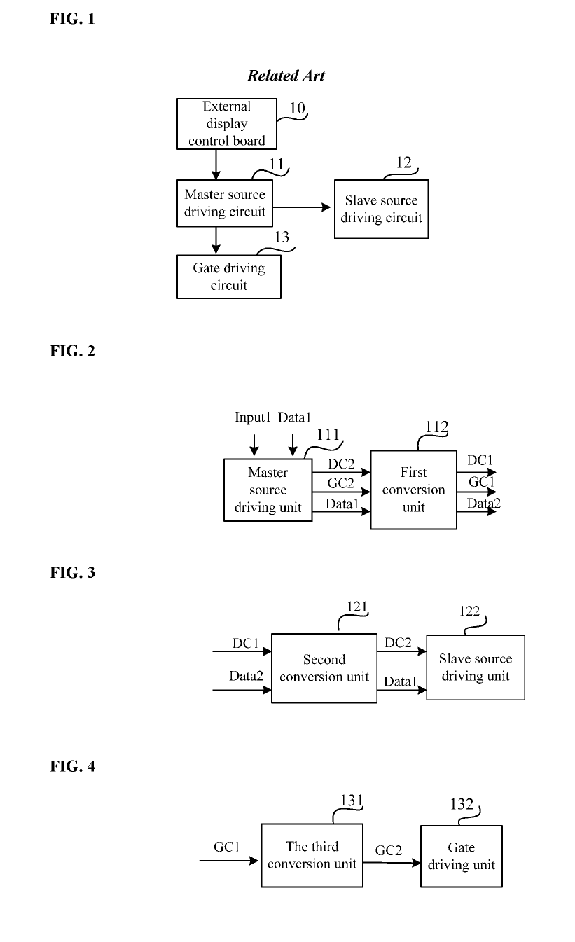

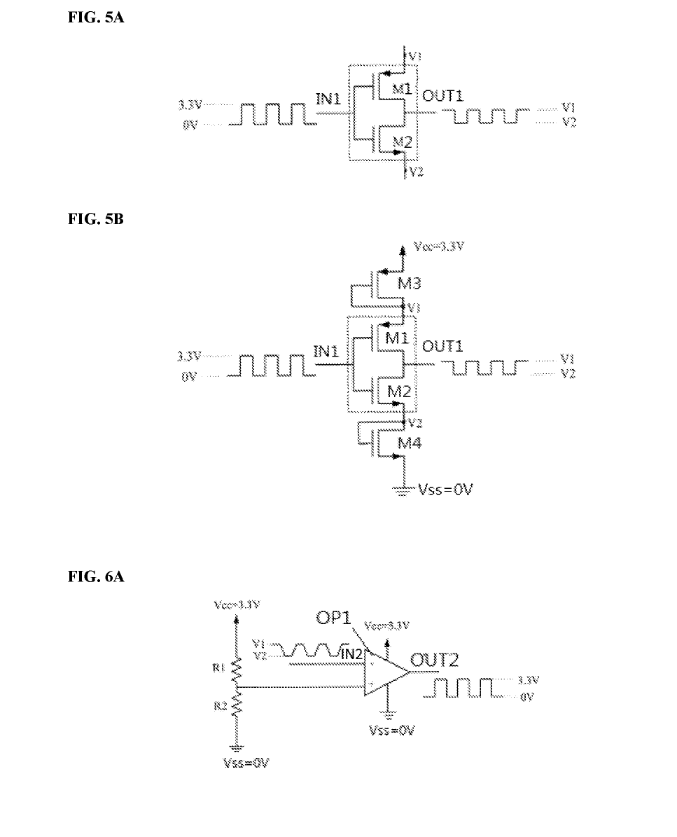

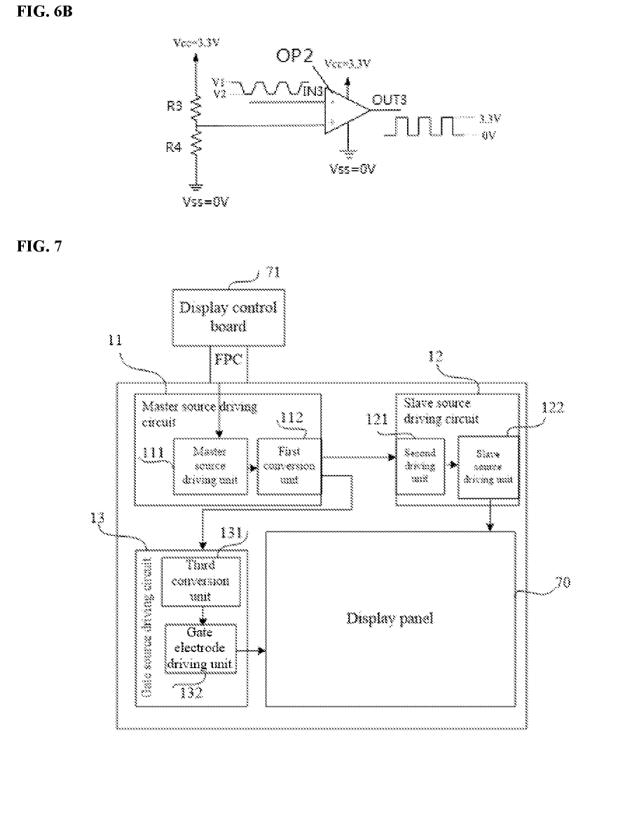

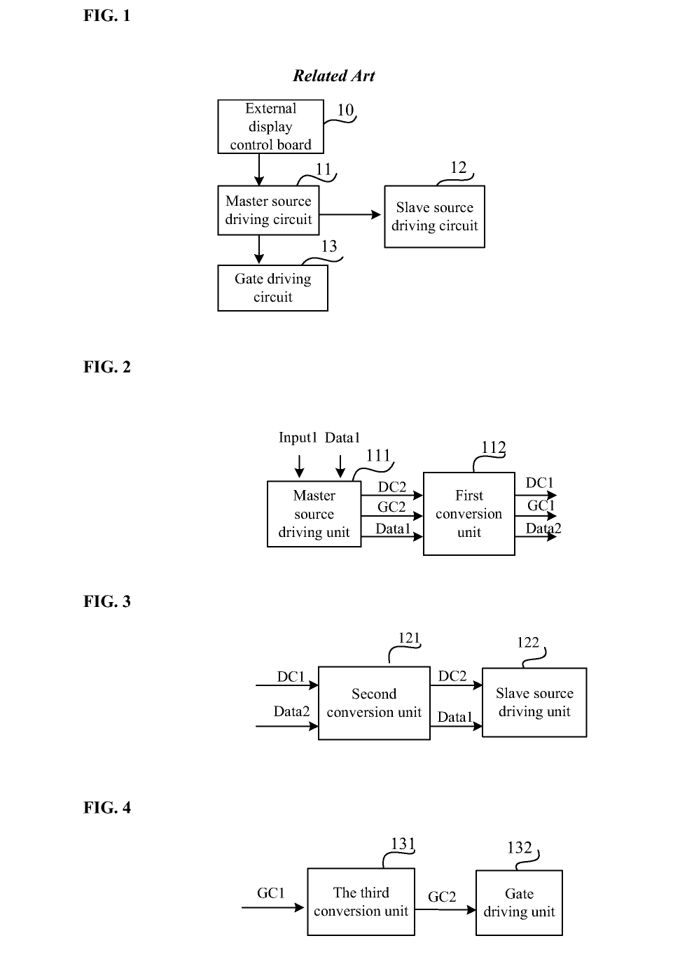

FIG. 1 is a diagram illustrating a display panel driving circuit. As shown in FIG. 1, the display panel driving circuit may include a master source driving circuit 11, a slave source driving circuit 12, and a gate electrode driving circuit 13. The master source driving circuit 11 may be connected an external display control board 10. As shown in FIG. 2, the master source driving circuit 11 may be configured to convert an input control signal Input1 from an external display control board 10 to a first data-driving control signal DC1 and a first gate-driving control signal GC1, and convert a first data signal Data1 from the external display control board 10 to a second data signal Data2. The slave source driving circuit 12 may be connected to the master source driving circuit 11, and be configured to receive the first data-driving control signal DC1 and the second data signal Data2. The gate electrode driving circuit 13 may be connected to the master source driving circuit 11, and be configured to receive gate-driving control signals.

In some embodiments, the frequency of the first data-driving control signal DC1 may be higher than the frequency of the input control signal Input1. The frequency of the first gate-driving control signal GC1 may be higher than the frequency of the input control signal Input1. The frequency of the second data signal Data2 may be higher than the frequency of the first data signal Data1.

The master source driving circuit 11 included in the disclosed display panel driving circuit may convert the input control signal Input1 from the external display control board 10 into the first data-driving control signal DC1 with a higher frequency that can be recognized by the slave source driving circuit 12 as well as into the first gate-driving control signal GC1 with a higher frequency that can be recognized by the gate electrode driving circuit 13. The master source driving circuit 11 may also convert the first data signal Data1 from the external display control board 10 to the second data signal Data2 with a higher frequency.

Further, the master source driving circuit 11 may transmit the first data-driving control signal DC1 and the second data signal Data2 to the slave source driving circuit 12, and transmit the first gate-driving control signal GC1 to the gate electrode driving circuit 13, to realize low power consumption, low electromagnetic interference, and high-speed signal transmission. In embodiments of the present disclosure, a driving method of master-slave source driving circuits may be used in the display panel driving circuit, which may increase the diversity of display panel driving circuits.

In one embodiment, a driving circuit may include one or more slave source driving circuits 12. In display devices containing a large size display panel, a plurality of slave source driving circuits 12 may be arranged sequentially on the top of a display panel from left to right, and may be used to drive data in multi-column data lines longitudinally arranged in the display panel. The master source driving circuit 11 may be connected to the external display control board 10 via a flexible printed circuit (FPC) board. In large-scale display devices, the distances between the master source driving circuit 11 and a plurality of slave source driving circuits 12 may be relatively long.

Accordingly, the voltage and frequency of the signal used for transmission may affect the transmission power consumption, the transmission speed and the electromagnetic interference. The voltage of signals transmitted between the master source driving circuit 11 and the slave source driving circuit 12, namely, the first data-driving control signal DC1 and the second data signal Data2, may need to be adjusted to a small value, and the corresponding frequency may be adjusted to a high value.

In one embodiment, a driving circuit may include one or more gate electrode driving circuits 13. In display devices containing a large size display panel, a plurality of gate electrode driving circuits 13 may be arranged sequentially on two sides of the display panel from top to bottom. The plurality of gate electrode driving circuits 13 may be used to drive gate electrodes in multi-row gate lines arranged horizontally in the display panel. The master source driving circuit 11 may be connected to the external display control board 10 via a flexible printed circuit (FPC) board. In large-scale display devices, the distances between the master source driving circuit 11 and a plurality of gate electrode driving circuits 13 may be relatively long.

Accordingly, the voltage and frequency of the signal used for transmission may affect the transmission power consumption, the transmission speed and the electromagnetic interference. The voltage used for signal (namely, the second gate-driving control signal GC2) transmission may need to be adjusted to a smaller value, and the corresponding frequency may be adjusted to a higher value.

In one embodiment, as shown in FIG. 2, the master source driving circuit 11 may include a master source driving unit 111 and a first conversion unit 112. The master source driving unit 111 may be configured to receive an input control signal Input1, and convert the input control signal Input1 to a second data-driving control signal DC2 and a second gate-driving control signal GC2. The first conversion unit 112 may be configured to convert the second data-driving control signal DC2 to the first data-driving control signal DC1, and convert the second gate-driving control signal GC2 to the first gate-driving control signal GC1, and convert the first data signal Data1 to the second data signal Data2. The external display control board 10 may transmit the first data signal Data1 to the first conversion unit 112 via the master source driving unit 111, or may transmit the first data signal Data1 to the first conversion unit 112 via the external display control board 10.

Specifically, FIG. 2 is a diagram illustrating an exemplary master source driving circuit 11 included in a display panel driving circuit. As shown in FIG. 2, the disclosed master source driving circuit 11 includes a master source driving unit 111 and a first conversion unit 112. The master source driving unit 111 may be configured to receive input control signal Input1 and the first data signal Data1 from the external display control board 10 (not illustrated in FIG. 2), and convert the input control signal Input1 to the second data-driving control signal DC2 and the second gate-driving control signal GC2. The first conversion unit 112 may be used to convert the second data-driving control signal DC2 to the first data-driving control signal DC1, convert the second gate-driving control signal GC2 to the first gate-driving control signal GC1, and convert the first data signal Data1 to the second data signal Data2. The voltages and speeds of the first data-driving control signal DC1, the first gate-driving control signal GC1, and the second data signal Data2 may be adjusted.

The voltages of the signals (the voltage of the first data-driving control signal DC1, the voltage of the second gate-driving control signal GC2, and the voltage of the second data signal Data2) used for transmission may be controlled to be relatively small to reduce the power consumption during the signal transmission process. The speeds (the speed of the first data-driving control signal DC1, the speed of the first gate-driving control signal GC1, and the speed of the second data signal Data2) and frequencies of signals used for transmission may be controlled to be relatively high to realize low electromagnetic interference and high-speed signal transmission.

The type of input control signal Input1, the type of the second data-driving control signal DC2, the type of the second gate-driving control signal GC2, and the type of the first data signal Data1 may be the same. The master source driving unit 111 may convert the input control signal Input1 to the second data-driving control signal DC2 and the second gate-driving control signal GC2. No signal type conversion may be involved. The master source driving circuit 11 included in the display panel driving circuit may have partial functions of a time schedule controller. For instance, control signals DE\HS\VS received from the input interface may be converted to control signals STH\TP\POL of a data-driving circuit and control signals STV\CPV\OE of a gate-driving circuit. However, the first conversion unit 112 may convert the input signal to an output signal with a higher frequency in order to realize low power consumption, low electromagnetic interference, and high-speed signal transmission.

FIG. 3 is a diagram illustrating a slave source driving circuit 12 included in a display panel driving circuit. As shown in FIG. 3, the slave source driving circuit 12 may include a second conversion unit 121 and a slave source driving unit 122. The second conversion unit 121 may be connected to the first conversion unit 112 (the first conversion unit 112 is not illustrated in FIG. 3), be configured to receive the first data-driving control signal DC1 and the second data signal DC2, and convert the second data signal Data2 to the first data signal Data1. The disclosed slave source driving unit 122 may be configured to provide data signals to data lines (not illustrated in FIG. 3) of the display panel based on the second data-driving control signal DC2 and the first data signal Data1.

FIG. 4 is a diagram illustrating a gate electrode driving circuit 13 included in a display panel driving circuit. As shown in FIG. 4, the gate electrode driving circuit 13 may include a third conversion unit 131 and a gate electrode driving unit 132. The third conversion unit 131 may be connected to the first conversion unit 112 (not illustrated in FIG. 4), and be configured to receive the first gate-driving control signal GC1, and convert the first gate-driving control signal GC1 to the second gate-driving control signal GC2. The gate electrode driving unit 132 may be configured to drive gate lines (not illustrated in FIG. 4) in the display panel based on the second gate-driving control signal GC2.

In one embodiment, the disclosed input control signal Input1 and the disclosed first data signal Data1 may be Transistor-Transistor Log (TTL) signals or Complementary metal-oxide-semiconductor (CMOS) signals. The first data-driving control signal DC1, the first gate-driving control signal GC1 and the second data signal Data2 may be High Speed Transceiver Logic (HSTL) signals or Stub Series Terminated Logic (SSTL) signals. That is, the first conversion unit 112 may convert TLL/COMS signals to HSTL/SSTL signals.

In another embodiment, the input control signal Input1 and the first data signal Data1 may be Low-Voltage Differential Signaling (LVDS) signals. The first data-driving control signal DC1, the first gate-driving control signal GC1, and the second data signal Data2 may be Mini-LVDS signals.

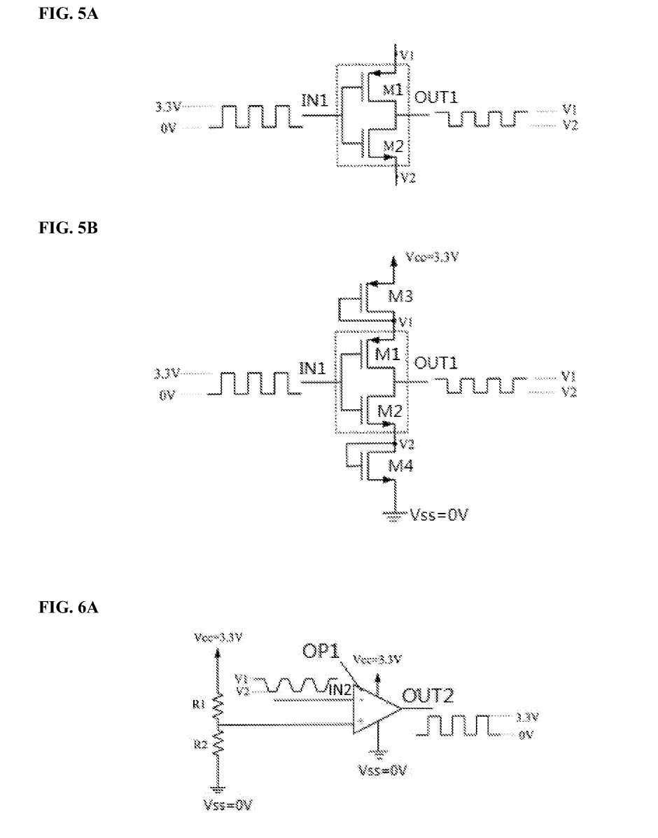

FIG. 5A is a circuit diagram illustrating a first conversion unit 112 included in a master source driving circuit 11 of a display panel driving. As shown in FIG. 5A, the first conversion unit 112 may include a first input terminal IN1 and a first output terminal OUT1. The first conversion unit 112 may also include a first conversion transistor M1, and a second conversion transistor M2. A gate electrode of the first conversion transistor M1 may be connected to the first input terminal IN1, a source electrode of the first conversion transistor M1 may be configured to receive a voltage with a first voltage level V1, and a drain electrode of the first conversion transistor M1 may be connected to the first output terminal OUT1. A gate electrode of the second conversion transistor M2 may be connected to the first input terminal IN1, a source electrode of the second conversion transistor M2 may be configured to receive a voltage with a second voltage level V2, and a drain electrode of the second conversion transistor M2 may be connected to the first output terminal OUT1. The first conversion transistor M1 may be a p-type transistor, and the second conversion transistor M2 may be an n-type transistor.

FIG. 5B is another circuit diagram illustrating a first conversion unit 112 included in a master source driving circuit 11 of a display panel driving circuit. As shown in FIG. 5B, and also referring to FIG. 5A, the first conversion unit 112 may further include a first protection transistor M3 and a second protection transistor M4. A gate electrode and a drain electrode of the first protection transistor M3 may both be connected to the source electrode of the first conversion transistor M1, and a source electrode of the first protection transistor M3 may be configured to receive a first supply voltage Vcc. A gate electrode and a drain electrode of the second protection transistor M4 may both be connected to the source electrode of the second conversion transistor M2, and the source electrode of the second protection transistor M4 may be configured to receive a second supply voltage Vss. The first protection transistor M3 may be a p-type transistor, and the second protection transistor M4 may be an n-type transistor.

The first conversion unit 112 as shown in FIG. 5A and FIG. 5B may convert TTL/CMOS signals to HSTL/SSTL signals. In operation, the first voltage level V1 may be larger than the second voltage level V2. In particular, the first voltage level V1 may be smaller than 3.3V, the second voltage level may be greater than 0V but smaller than the first voltage level V1, the first supply voltage Vcc, for example, may be 3.3 V, and the second supply voltage Vss, for example, may be 0 V. Thus, according to the general principles of transistors, because the first voltage level V1 is smaller than the first supply voltage Vcc, the first protection transistor M3 may be turned off, and because the second voltage level V2 is greater than the second supply voltage, the second protection transistor M4 may be turned off. When a voltage with a voltage level of 3.3 V is inputted, because the first voltage level V1 is smaller than 3.3V, the first conversion transistor M1 may be turned on, and because the second voltage level V2 is smaller than 3.3V, the second conversion transistor M2 may be turned off, thus the first voltage level V1 is outputted. Further, when a voltage with a voltage level of 0 V is inputted, because the first voltage level V1 is greater than 0 V, the first conversion transistor M1 may be turned off, and because the second voltage level V2 is greater than 0 V, the second conversion transistor M2 may be turned on, thus the second voltage level V2 is outputted.

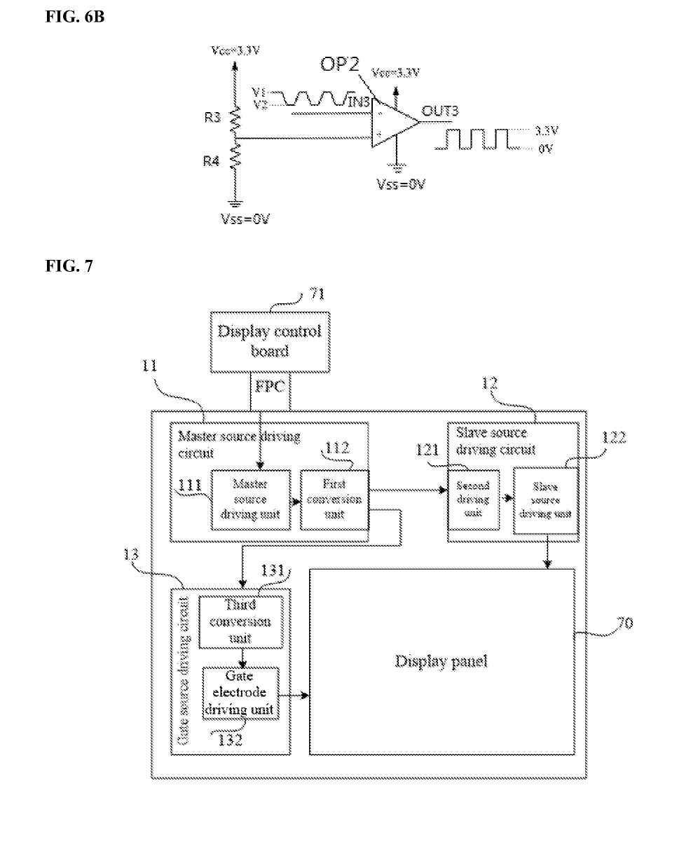

FIG. 6A is a circuit diagram illustrating a second conversion unit 121 included in a slave source driving circuit 12 of a display panel driving circuit. As shown in FIG. 6A, the second conversion unit 121 may include a second input terminal IN2 and a second output terminal OUT2. The second conversion unit 121 may also include a first operational amplifier OP1. An inverting input terminal of the first operational amplifier OP1 may be connected to the second input terminal IN2, a forward input terminal of the first operational amplifier OP1 may be configured to the first supply voltage Vcc via a first resistor R1 and may be configured to receive the second supply voltage Vss via a second resistor R2, and an output terminal of the first operational amplifier OP1 may be connected to the second output terminal OUT2.

In real operation, the first supply voltage Vcc may be 3.3 V, the second supply voltage Vss may be 0 V, and the two power supply ends of the first operational amplifier OP1 may be connected to the first supply voltage Vcc and the second supply voltage Vss, respectively.

As shown in FIG. 6A, the second conversion unit 121 may convert HSTL/SSTL signals to TTL/CMOS signals. For example, in FIG. 6A, HSTL/SSTL signals that alternatively output the first voltage level V1 and the second voltage level V2 may be inputted into the second input terminal IN2, and TTL/CMOS signals with alternative voltage levels of 3.3 V and 0 V may be outputted from the second output terminal OUT2.

FIG. 6B is a circuit diagram illustrating a third conversion unit 131 included in the gate electrode driving circuit 13 of a display panel driving circuit. As shown in FIG. 6B, a third conversion unit 131 may include a third input terminal IN3 and a third output terminal OUT3. The third conversion unit 131 may also include a second operational amplifier OP2. An inverting input terminal of the second operational amplifier OP2 may be connected to the third input terminal IN3, a forward input terminal of the second operational amplifier OP2 may be configured to receive the first supply voltage Vcc via a third resistor R3 and receive the second supply voltage Vss via a fourth resistor R4, and an output terminal of the second operational amplifier OP2 may be connected to the third output terminal OUT3.

In real operation, the first supply voltage Vcc may be 3.3 V, the second supply voltage Vss may be 0 V, and the two power supply ends of the second operational amplifier OP2 may be configured to receive the first supply voltage Vcc and the second supply voltage Vss, respectively.

As shown in FIG. 6B, the third conversion unit 131 may convert HSTL/SSTL signals to TTL/CMOS signals. For example, in FIG. 6B, HSTL/SSTL signals that alternatively output the first voltage level V1 and the second voltage level V2 may be inputted into the third input terminal IN3, and the TTL/CMOS signals with alternative voltage levels of 3.3 V and 0 V may be outputted from the third output terminal OUT3.

The disclosed display panel driving method may include a master source driving circuit 11, a slave source driving circuit 12, and a gate electrode driving circuit 13. The master source driving circuit 11 may convert an input control signal Input1 from an external display control board 10 into a first data-driving control signal DC1 and a first gate-driving control signal GC1, and convert a first data signal Data1 from the external display control board 10 into a second data signal Data2. The slave source driving circuit 12 may be configured to receive a first data-driving control signal DC1 and a second data signal Data2. The gate electrode driving circuit 13 may be configured to receive the first gate-driving control signal GC1. The frequency of the first data-driving control signal DC1 is higher than the frequency of the input control signal Input1. The frequency of the first gate-driving control signal GC1 is higher than the frequency of the input control signal Input1. The frequency of the second data signal Data2 is higher than the frequency of the first data signal Data1.

The driving method of the display panel may, via a master source driving circuit 11, convert the input control signal Input1 from the external display control board 10 into the first data-driving control signal DC1 with a higher frequency that can be recognized by the source driving circuit as well as into the first gate-driving control signal GC1 with a higher frequency that can be recognized by the source driving circuit. The driving method of the display panel may also convert the first data signal Data1 from the external display control board 10 to the second data signal Data2 with a higher frequency.

The disclosed master source driving circuit 11 may transmit the first data-driving control signal DC1 and the second data signal Data2 to the slave source driving circuit 12, and transmit the first gate-driving control signal GC1 to the gate electrode driving circuit 13 to realize low power consumption, low electromagnetic interference, and high-speed signal transmission. The disclosed display panel driving circuit may also use the driving method of master-slave source driving circuits, thus increasing the diversity of display panel driving circuits.

The master source driving circuit 11 may convert the input control signal Input1 from the external display control board 10 into the first data-driving control signal DC1 as well as into the first gate-driving control signal GC1, and convert the first data signal Data1 from the external display control board 10 to the second data signal Data2.

The master source driving unit 111 may be configured to receive the input control signal Input1 and convert the input control signal Input1 into the second data-driving control signal DC2 as well as into the second gate-driving control signal GC2. The first conversion unit 112 may convert the second data-driving control signal DC2 to the first data-driving control signal DC1, may convert the second gate-driving control signal GC2 to the first gate-driving control signal GC1, and may convert the first data signal Data1 to the second data signal Data2.

The type of input control signal Input1, the type of the second data-driving control signal DC2, the type of the second gate-driving control signal GC2, and the type of the first data signal Data1 may be the same.

The disclosed driving circuit may also include the master source driving unit 111 receiving the first data signal Data1 from the external display control board 10, and transmitting the first data signal Data1 to the first conversion unit 112. Optionally, the driving circuit may also include the first conversion unit 112 receiving the first data signal Data1 from the external display control board 10.

Specifically, the steps of the slave source driving circuit 12 receiving the first data-driving control signal DC1 and the second data signal Data2 may include the second conversion unit 121 receiving the first data-driving control signal DC1 and the second data signal Data2.

The driving method for a display panel may also include the second conversion unit 121 converting the first data-driving control signal DC1 to the second data-driving control signal DC2, and converting the second data signal Data2 to the first data signal Data1; the slave source driving unit 122 may provide data signals to the data lines of the display panel based on the second data-driving control signal DC2 and the first data signal Data1.

The steps of the gate electrode driving circuit 13 receiving the first gate-driving control signal GC1 may include the third conversion unit 131 receiving the first gate-driving control signal GC1.

The driving method for a display panel may also include the third conversion unit 131 converting the first gate-driving control signal GC1 to the second gate-driving control signal GC2, and the gate electrode driving unit 132 driving the gate lines in the display panel based on the second gate-driving control signal GC2.

The display panel driving circuit may include one or more slave source driving circuits 12. The display panel driving circuit may also include one or more gate electrode driving circuits 13.

The disclosed display device may include a display panel driving circuit. For example, as shown in FIG. 7, the disclosed display device may include a display panel 70, a display control board 71, and a display panel driving circuit. The display panel driving circuit may also include a master source driving circuit 11, a slave source driving circuit 12, and a gate electrode driving circuit 13. The master source driving circuit 11 may be connected to the display control panel 71 via a flexible printed circuit (FPC). The master source driving unit 111 may be configured to receive input control signal Input1 from the display control panel 71 and the first data signal Data1, and may convert the input control signal Input1 into the second data-driving control signal DC2 as well as into the second gate-driving control signal GC2. The first conversion unit 112 may be used to convert the second data-driving control signal DC2 to the first data-driving control signal DC1, may be used to convert the second gate-driving control signal GC2 to the first gate-driving control signal GC1, and may convert the first data signal Data1 to the second data signal Data2.

The slave source driving circuit 12 may include a second conversion unit 121 and a slave driving unit 122. The second conversion unit 121 may be connected to the first conversion unit 112, and may be configured to receive the first data-driving control signal DC1 and the second data signal Data2. The second conversion unit 121 may convert the first data-driving control signal DC1 to the second data-driving control signal DC2, and may convert the second data signal Data2 to the first data signal Data1. The slave source driving unit 122 may provide data signals to the data lines (not illustrated in FIG. 7) of the display panel 70 based on the second data-driving control signal DC2 and the first data signal Data1.

The gate electrode driving circuit 13 may include a third conversion unit 131 and a gate electrode driving unit 132. The third conversion unit 131 may be connected to the first conversion unit 112, and be configured to receive the first gate-driving control signal GC1, and may covert the first gate-driving control signal GC1 to the second gate-driving control signal GC2. The gate electrode driving unit 132 may drive the gate lines (not illustrated in FIG. 7) on the display panel based on the second gate-driving control signal GC2.

In operation, a display panel driving circuit may include one or more slave source driving circuits 12. A plurality of slave source driving circuits 12 may be arranged sequentially on top of the display panel from left to right, and may drive data in multi-column data lines longitudinally arranged on the disclosed display panel. A display panel driving circuit may include one or more gate electrode driving circuits 13. A plurality of gate electrode driving circuits 13 may be arranged sequentially on two sides of the display panel from top to bottom, and may drive gate electrodes in a multi-row gate lines horizontally arranged on the disclosed display panel.

When the display panel driving circuit included in the display panel in FIG. 7 is in operation, the frequencies of the first data-driving control signal DC1 and the second data signal Data2 transmitted between the master source driving circuit 11 and the slave source driving circuit 12 may be relatively high. The frequency of the first gate-driving control signals GC1 transmitted between the master source driving circuit 11 and the gate electrode driving circuit 13 may also be relatively high. The voltages and speeds of the first data-driving control signal DC1, the second data signal Data2, and the first gate-driving control signal GC1 may be adjusted to realize low power consumption, low electromagnetic interference, and high-speed signal transmission. The display panel driving circuit may increase the diversity of display panel driving circuits by applying a method of master-slave source driving circuits.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1-21. (canceled)

22. A display panel driving circuit, comprising:
a master source driving circuit, a slave source driving circuit, and a gate electrode driving circuit, wherein:
the master source driving circuit is configured to convert an input control signal from an external display control board to a first data-driving control signal and a first gate-driving control signal, and convert a first data signal from the external display control board to a second data signal;
the slave source driving circuit is coupled to the master source driving circuit and data lines of a display panel, and is configured to receive the first data-driving control signal and the second data signal; and
the gate electrode driving circuit is coupled to the master source driving circuit and gate lines of the display panel, and is configured to receive a first gate-driving control signal.

23. The display panel driving circuit according to claim 22, wherein:
a frequency of the first data-driving control signal and a frequency of the first gate-driving control signal are both higher than a frequency of the input control signal, and a frequency of the second data signal is higher than a frequency of the first data signal.

24. The display panel driving circuit according to claim 23, wherein:
the master source driving circuit comprises a master source driving unit and a first conversion unit;
the master source driving unit is configured to receive the input control signal and convert the input control signal to a second data-driving control signal and a second gate-driving control signal; and
the first conversion unit is configured to convert the second data-driving control signal to the first data-driving control signal, convert the second gate-driving control signal to the first gate-driving control signal, and convert the first data signal to the second data signal.

25. The display panel driving circuit according to claim 24, wherein:
a type of the input control signal, a type of the second data-driving control signal, a type of the second gate-driving control signal, and a type of the first data signal are the same.

26. The display panel driving circuit according to claim 25, wherein:
the master source driving unit is configured to receive the first data signal from the external display control board, and transmit the first data signal to the first conversion unit.

27. The display panel driving circuit according to claim 25, wherein:
the first conversion unit is configured to receive the first data signal from the master source driving unit.

28. The display panel driving circuit according to claim 25, wherein:
the slave source driving circuit comprises a second conversion unit and a slave source driving unit;
the second conversion unit is configured to receive the first data-driving control signal and the second data signal, convert the first data-driving control signal to the second data-driving control signal, and convert the second data signal to the first data signal; and
the slave source driving unit is configured to provide data signals to the data lines of the display panel based on the second data-driving control signal and the first data signal.

29. The display panel driving circuit according to claim 25, wherein:
the gate electrode driving circuit comprises a third conversion unit and a gate electrode driving unit;
the third conversion unit is configured to receive the first gate-driving control signal, and convert the first gate-driving signal to the second gate-driving control signal; and
the gate electrode driving unit is configured to drive the gate lines on the display panel based on the second gate-driving control signal.

30. The display panel driving circuit according to claim 22, wherein the display panel driving circuit includes one or more slave source driving circuits, or one or more gate electrode driving circuits.

31. The display panel driving circuit according to claim 22, wherein:
the input control signal and the first data signal are TTL signals or CMOS signals, and
the first data-driving control signal, the first gate-driving control signal, and the second data signal are HSTL signals or SSTL signals.

32. The display panel driving circuit according to claim 22, wherein:
the input control signal and the first data signal are LVDS signals, and
the first data-driving control signal, the first gate-driving control signal, and the second data signal are Mini-LVDS signals.

33. The display panel driving circuit according to claim 23, wherein the first conversion unit comprises:
a first input terminal;
a first output terminal;
a first conversion transistor, wherein a gate electrode of the first conversion transistor is coupled to the first input terminal, a source electrode of the first conversion transistor is configured to receive a first voltage, and a drain electrode of the first conversion transistor is coupled to the first output terminal;
a second conversion transistor, wherein a gate electrode of the second conversion transistor is coupled to the first input terminal, a drain electrode of the second conversion transistor is connected to the first output terminal, and a source electrode of the second conversion transistor is configured to receive a second voltage, and
the first conversion transistor is a p-type transistor and the second conversion transistor is an n-type transistor.

34. The display panel driving circuit according to claim 27, wherein the second conversion unit comprises:
a second input terminal;
a second output terminal; and
a first operational amplifier, wherein an inverting input terminal of the first operational amplifier is coupled to the second input terminal, a forward input terminal of the first operational amplifier is configured to receive a first supply voltage via a first resistor and receive a second supply voltage via a second resistor, and an output terminal of the first operational amplifier is coupled to the second output terminal.

35. The display panel driving circuit according to claim 28, wherein the third conversion unit comprises:
a third input terminal;
a third output terminal; and
a second operational amplifier,
wherein an inverting input terminal of the second operational amplifier is coupled to the third input terminal, a forward input terminal is configured to receive the first supply voltage via a third resistor and receive the second supply voltage via a fourth resistor, and an output terminal of the second operational amplifier is coupled to the third output terminal.

36. A driving method for a display panel, applied to the display panel driving circuit according to claim 22, comprising:
converting the input control signal, by the master source driving circuit, from the external display control board to the first data-driving control signal and the first gate-driving control signal, and converting, by the master source driving circuit, the first data signal from the external display panel to the second data signal;
receiving, by the slave source driving circuit, the first data-driving control signal and the second data signal; and
receiving, by the gate electrode driving circuit, the first gate-driving control signal.

37. The driving method according to claim 36, wherein:
the frequency of the first data-driving control signal is higher than the frequency of the input control signal, the frequency of the first gate-driving control signal is higher than the frequency of the input control signal, and the frequency of the second data signal is higher than the frequency of the first data signal.

38. The driving method according to claim 36, further comprising:
converting, by the master source driving circuit, the input control signal from the external display control board to the first data-driving control signal and the first gate-driving control signal, and converting, by the master source driving circuit, the first data signal from the external display control board to the second data signal;
receiving, by the master source driving unit, the input control signal and converting the input control signal to the second data-driving control signal and the second gate-driving control signal; and
converting the second data-driving control signal to the first data-driving control signal, converting the second gate-driving control signal to the first gate-driving control signal, and converting the first data signal to the second data signal, by the first conversion unit.

39. The driving method according to claim 38, further comprising:
receiving the first data signal from the external display control board and transmitting the first data signal to the first conversion unit by the master source driving unit; and
receiving the first data signal from the master source driving unit by the first conversion unit, wherein:
the type of the input control signal, the type of the second data-driving control signal, the type of the second gate-driving control signal, and the type of the first data signal are the same.

40. The driving method according to claim 36, wherein receiving the first data-driving control signal and the second data signal by the slave source driving circuit comprises:
receiving, by the second conversion unit, the first data-driving control signal and the second data signal;
converting, by the second conversion unit, the first data-driving control signal to the second data-driving control signal, and converting, by the second conversion unit, the second data signal to the first data signal; and
providing, by the slave source driving unit, data signals to the data lines of the display panel based on the second data-driving control signal and the first data signal.

41. The driving method according to claim 36, wherein receiving the first gate-driving control signal by the gate electrode driving circuit comprises:
receiving the first gate-driving control signal by the third conversion unit;
converting, by the third conversion unit, the first gate-driving control signal to the second gate-driving control signal; and
driving, by the gate electrode driving unit, the gate lines in the display panel based on the second gate-driving control signal.

42. A display device, comprising a display panel and a display panel driving circuit according to claim 22.
